(19) United States
(12) Patent Application Publication
(10) Pub. No.: US 2002/0020762 A1
(43) Pub. Date: Feb. 21, 2002

(54) Liquid atomizer device

(76) Inventors: Titus Selzer, Munich (DE); Sven Rosenbeiger, Munich (DE)

Correspondence Address: MERCHANT & GOULD PC, P.O. BOX 2903, MINNEAPOLIS, MN, 55402-0903, US

(21) Appl. No.: 09/917,599

(22) Filed: Jul. 27, 2001

(30) Foreign Application Priority Data
Jul. 28, 2000 (DE) 100 36 906.5

(51) Int. Cl. B05B 1/32; A62C 13/62; A62C 13/66

(52) U.S. Cl. 239/390; 239/391; 239/392; 239/393; 239/394; 239/372; 239/456; 239/457

(57) ABSTRACT

The liquid atomizer device consists of two housing parts (A, B) which can be brought into engagement with each other. An inner part (5) of an atomizer nozzle is formed integrally with the first housing part (A), an outer part (16) is formed integrally with the second housing part (B). The outer part (16) has recesses (20) which guarantee a form-fitting seat and thus a formation of liquid channels (18) which compensates for production inaccuracies.

The invention refers to a liquid atomizer device for the generation of an aerosol above all for inhalation purposes.

From EP 0 540 774 A1 there is known a liquid atomizer device which consists of two housing parts which can be brought into engagement with each other such that an atomizer nozzle is formed of an inner part and an outer part. In order to ensure that the parts forming the atomizer nozzle are aligned as good as possible, in the housing part comprising the outer part of the atomizer nozzle there is provided a tapered wall section between a bayonet lock ring and an air supply channel. Thereby the air supply channel can be shifted when the two housing parts are connected with each other. Since at the air supply channel, to be more precise at the end lying opposite the tapered wall section, the outer part of the atomizer nozzle is arranged, a displacement of the outer part of the atomizer nozzle with respect to the inner part is guaranteed when the two housing parts are assembled.

Proceeding from this prior art, the object of the invention is to provide an improved liquid atomizer device without abandoning the advantages of the known design.

Said object is solved by a liquid atomizer device with the features of claim 1.

According to the invention, the atomizer device is developed such that the outer part of the atomizer nozzle has at least one recess by which the section of the outer part in which the groove for the formation of a liquid channel is arranged, is movable or displaceable/dislocatable such that the putting together of the outer and inner part of the atomizer nozzle results in an alignment of the two parts. Due to said measure, production inaccuracies can be compensated for and less narrow manufacturing tolerances can be given without impairing the technical quality of the liquid channels.

The recesses of the outer part of the atomizer nozzle can be formed like a slot or an essentially triangular notch.

Advantageously, two recesses are arranged diametrically which, in case there are two diametrically arranged liquid channels, are preferably aligned perpendicular thereto.

Further advantageous developments result from the subclaims.

Also the inventive atomizer device only consists of two housing parts which can be easily brought into engagement with each other. The two-part structure of the inventive atomizer device is advantageous for the user and results in the fact that the atomizer device can be disassembled and cleaned in a very simple manner. This applies in particular with respect to the liquid channels which, in an advantageous development, are directly accessible after the disassembling of the atomizer device. However, after the putting together of the nozzle parts, by the inventive recess there are always formed liquid channels which meet high accuracy requirements.

The invention will be described in more detail in the following by means of an embodiment and with reference to the drawings, in which:

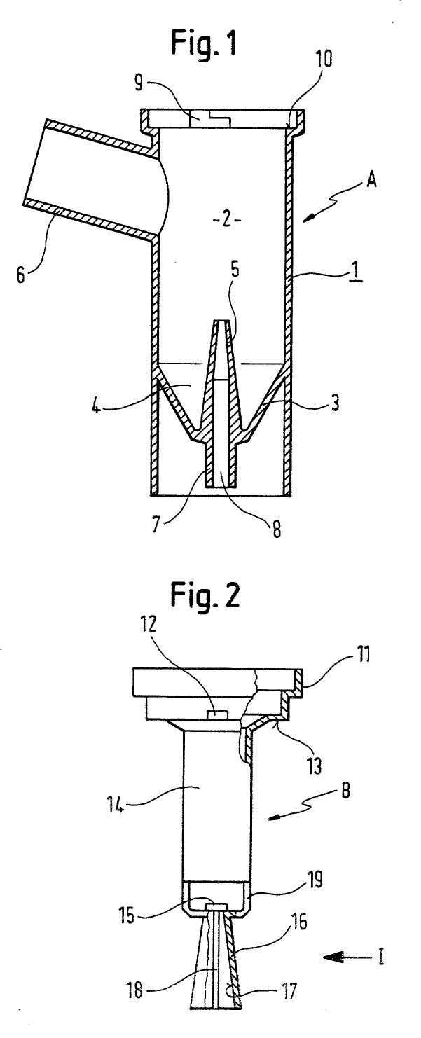

FIG. 1 is a sectional view of a first housing part of an inventive liquid atomizer device.

FIG. 2 is a partial sectional view of a second housing part of an inventive liquid atomizer device.

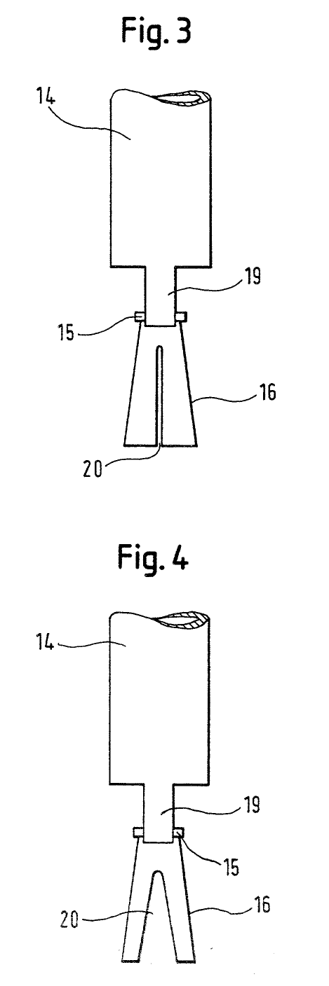

FIG. 3 is an enlarged representation of a first development of the outer part of the atomizer nozzle of FIG. 2.

FIG. 4 is an enlarged representation of a second development of the outer part of the atomizer nozzle of FIG. 2.

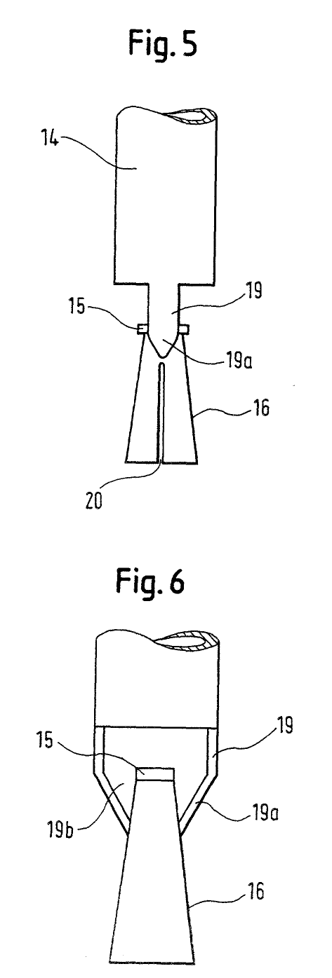

FIG. 5 is an enlarged representation of a third development of the outer part of the atomizer nozzle of FIG. 2.

FIG. 6 is an enlarged representation of the third development of the outer part of the atomizer nozzle in another view; and

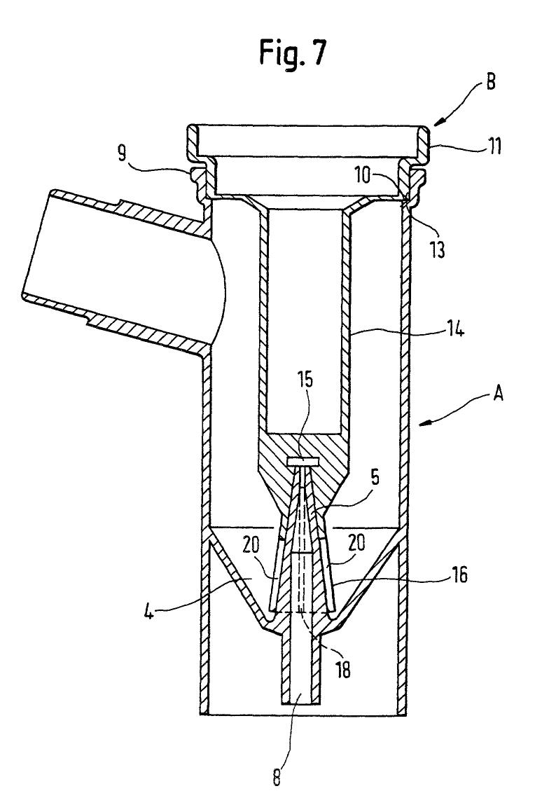

FIG. 7 is a sectional view of the inventive liquid atomizer device composed of the two housing parts of FIG. 1 and 2.

In FIG. 1 there is represented a first housing part A of an embodiment of the inventive liquid atomizer device. The cylindrical basic body 1 encloses an atomization chamber 2 which is closed towards the bottom by a wall 3 of a liquid collecting section 4 and an inner part 5 of the atomizer nozzle. An aerosol outlet pipe 6 is arranged laterally at the first housing part A. The cylindrical basic body 1, the wall 3 of the fluid collecting chamber, the inner part 5 of the atomizer nozzle and the aerosol outlet pipe 6 are formed in one piece.

The inner part 5 of the atomizer nozzle is preferably designed like a pointed cone and, at the end lying outside the atomization chamber 2, has a connecting piece 7 for the compressed gas conduit via which the pressurized gas, in most cases air, is supplied to a compressed gas channel 8 in the inner part 5 of the atomizer nozzle. At the end of the inner part 5 projecting into the atomization chamber 2 the supplied compressed gas flows out.

At the end lying opposite the liquid collecting section 4, the first housing part has a first connecting element 9, advantageously in the form of grooves of a bayonet lock. As a connecting element 9 there can also be provided a suitable thread or a snap-in or catch lock. Furthermore, at the first housing part A there is provided a first stop face 10 which cooperates with the second housing part which will be described in the following.

In FIG. 2, the second housing part B of the embodiment of the inventive atomizer device is shown. Also the second housing part B is substantially rotationally symmetrical. At its upper end, the second housing part B has a second connecting element 11 which corresponds to the connecting element 9 of the first housing part A. By way of example, in FIG. 2 there is represented a tongue or bracket 12 which can engage into the grooves of the bayonet lock shown in FIG. 1 and can be locked. A second stop face 13 of the second housing part B is provided for coming into engagement with the stop face 10 of the first housing part A.

An air supply channel 14 is integrally formed with the second connecting element 11, said air supply channel 14 being open at its upper end in the area of the second connecting element 11 as well as also at its opposite lower end. At the lower end of the air supply channel 14 there is also formed a gas flow control means which extends transversely to the substantially circular opening of the air supply channel 14. Below the gas flow control means 15 there is provided an outer part 16 of the atomizer nozzle which, as will be described in more detail below in connection with FIG. 7, is assembled with the inner part 5 of the atomizer nozzle. The inner wall 17 of the outer part 16 of the atomizer nozzle is formed suitably corresponding to the form of the inner part 5 of the atomizer nozzle. Furthermore, the inner wall has at least one, but preferably two diametrically opposite grooves 18 which form liquid channels when the two nozzle parts are put together. Besides, the surfaces of the inner and outer parts rest upon each other. When two grooves 18 are provided, they have to be arranged preferably on both sides of the gas flow control means 15 such that a straight connection line extends between them perpendicularly to the plane of the gas flow control means 15.

In FIG. 3 there is shown the outer part 16 of the atomizer nozzle in an enlarged representation and viewed from the direction I according to FIG. 2.

As becomes obvious from FIG. 3, a shackle or bow 19, which is also recognizable in FIG. 2, effects substantially the secure mounting of the outer part 16 of the atomizer nozzle at the air supply channel 14. Also the gas flow control means 15 contributes enormously to the mounting, but only the shackle or bow 19 guarantees a buckle-proof and twist-proof fixation.

Furthermore, in FIG. 3 there can also be seen a recess 20 which breaks through the outer part 16 of the atomizer nozzle in the form of a slot. From the representation of FIG. 3 it also becomes obvious that preferably two recesses are provided diametrically opposed to each other in the outer part 16 of the atomizer nozzle. By the recesses 20, in the outer part 16 of the atomizer nozzle there are formed wall sections in which the grooves 18 forming the liquid channels are positioned. By the recesses 20 the two sections of the outer part 16 of the atomizer nozzle are sufficiently movable with respect to each other, and when the outer part 16 of the atomizer nozzle is put onto the inner part 5 they can be displaced relative to the latter such that an arrangement of the two sections of the outer parts 16 of the atomizer nozzle with a fit as exact as possible is obtained. Thereby the formation of the liquid channels is optimized, as the inner surface section 17 of the outer part 16 of the atomizer nozzle in which the liquid channel groove 18 is formed, rests reliably on the outer surface of the inner part 5 of the atomizer nozzle in a positively-locking manner. Production inaccuracies are compensated for, as the two movable sections of the outer part 16 of the atomizer nozzle guarantee an exact fit of the sections forming the liquid channels. The movability is obtained by the recess 20 which, according to FIG. 3, can be formed as a small slot or which, according to FIG. 4, can be formed like a wide notch with a substantially triangular form.

Preferably, in the outer part 16 of the atomizer nozzle there are provided two recesses 20 which lie diametrically opposite to each other. Said design is shown in FIG. 3 and 4. But also one or more than two recesses 20 can be provided, in particular when one or more than two liquid channels 18 are provided.

The shape, i.e. form and size of the recesses 20 in the outer part 16 of the atomizer nozzle is also freely selectable in wide ranges, as already indicated by FIG. 3 and 4. The design according to FIG. 4 is advantageous as thereby also an enormous material saving is achieved and a component is obtained the form of which can be easily finished during production.

In FIG. 5 there is shown another design of the outer part 16 of the atomizer nozzle in which the shackle or bow 19 is provided with a wedge-shaped end section 19a. The wedge-shaped end section 19a of the shackle 19 makes a contribution to the stability of the outer part 16 of the atomizer nozzle and can also be used in case of a two-part atomizer nozzle independent of the recesses 20. In FIG. 6 there is shown the design of the shackle 19 with a wedge-shaped end section 19a viewed from the direction shown also in FIG. 2. As becomes obvious from FIG. 6, the wedge-shaped section 19a of the shackle 19 extends from the lower edge of the shackle 19 obliquely receding towards the outer surface of the outer part 16 of the atomizer nozzle. In the resulting triangle there is formed a wall surface 19b which connects the shackle 19 with the outer part 16 of the atomizer nozzle.

In FIG. 7 there is shown the inventive atomizer device in an assembled state.

The outer part 16 of the atomizer nozzle rests upon the inner part 5 of the atomizer nozzle, as the outer surface and the inner surface of the two parts 5, 16 are suitably adapted to each other, and by the recesses 20 there is guaranteed a formfitting resting of the sections of the outer part 16 forming the liquid channels on the inner part 5. The outer surface of the inner part 5 together with the grooves 18 provided in the inner surface 17 of the outer part 16 form liquid channels which connect the liquid collecting section with the upper end of the atomizer nozzle. By the inventive recesses in the outer part 16 of the atomizer nozzle there is achieved an extraordinary manufacturing-technical quality of the liquid channels 18, as the production inaccuracies are compensated for by the movability of the two sections of the outer part 16 which are formed by the recesses.

What is claimed is:

1. A liquid atomizer device, having
a first housing part (A) which comprises
a first inner part (5) of an atomizer nozzle and
a first connecting element (9) for the connection of the first housing part with a further housing part for the formation of an atomization chamber (2), and
a second housing part (B) which comprises
an outer part (16) of the atomizer nozzle which can be brought into engagement with the inner part (5) for the formation of the atomizer nozzle and in which at least one groove (18) is formed for the formation of a liquid channel of the atomizer nozzle, and
a second connecting element (11) which can be brought into engagement with the first connecting element (9) for the connection of the second housing part with the first housing part,
characterized in that
the outer part (16) of the atomizer nozzle has at least one recess (20) by means of which a movability of the section of the outer part (16) comprising the groove (18) is achieved such that the inner part (5) and the outer part (16) of the atomizer nozzle are alignable with respect to each other.

2. The liquid atomizer device according to claim 1,
characterized in that
the inner part (5) has a compressed gas channel (8) in the interior.

3. The liquid atomizer device according to anyone of claims I and 2, characterized in that
the inner part (5) is formed integrally with a wall (3) of a liquid collecting section (4) in the first housing part (A).

4. The liquid atomizer device according to anyone of claims 1 through 3, characterized in that
the inner part (5) is formed such that its continuation forms a compressed gas supply (7).

5. The liquid atomizer device according to anyone of claims 1 through 4, characterized in that
the outer part (16) is integrally formed with the second housing part (B).

6. The liquid atomizer device according to anyone of claims 1 through 5, characterized in that
the outer part (16) in its interior is formed like a pointed cone with an inner surface (17).

7. The liquid atomizer device according to anyone of claims 1 through 6, characterized in that
the second housing part (B) has a gas flow control means (15) which is arranged lying opposite the outlet end of the atomizer nozzle.

8. The liquid atomizer device according to anyone of claims 1 through 7, characterized in that
the second housing part (B) has an air supply channel (14) at the one end of which the second connecting element (11) is arranged and at the other end of which the outer part (16) of the atomizer nozzle is arranged.

9. The liquid atomizer device according to claim 8,
characterized in that
a shackle or bow (19) is formed between the air supply channel (14) and the outer part (16) of the atomizer nozzle.

10. The liquid atomizer device according to claim 9,
characterized in that
the shackle or bow (19) has a wedge-shaped end section (19a).

11. The liquid atomizer device according to claim 10,
characterized in that
between the wedge-shaped end section (19a) and the outer part (16) of the atomizer nozzle there is formed a substantially triangular wall section (19b).

12. The liquid atomizer device according to anyone of claims 1 through 11,
characterized in that
two recesses (20) are provided in the outer part (16) of the atomizer nozzle lying diametrically opposed to each other.

13. The liquid atomizer device according to claim 12,
characterized in that
the two recesses (20) lying diametrically opposite to each other are arranged perpendicularly to two grooves (18) lying diametrically opposite to each other and forming liquid channels.

14. The liquid atomizer device according to anyone of claims 1 through 13,
characterized in that
the one or several recesses (20) have the form of a slot.

15. The liquid atomizer device according to anyone of claims 1 through 13,
characterized in that
the one or several recesses (20) have the form of a substantially triangular notch.
